(19) United States
(12) Patent Application Publication
(10) Pub. No.: US 2007/0209444 A1
(43) Pub. Date: Sep. 13, 2007

(54) Pipe Tension Measuring Device

(76) Inventor: Knud Nielsen, Svenstrup (DK)

Correspondence Address: BIRCH STEWART KOLASCH & BIRCH, PO BOX 747, FALLS CHURCH, VA, 22040-0747, US

(21) Appl. No.: 11/578,998

(22) PCT Filed: Apr. 18, 2005
(86) PCT No.: PCT/DK05/00264

§ 371 Date: Oct. 19, 2006

(30) Foreign Application Priority Data
Apr. 19, 2004 (DK) PA200400618

(51) Int. Cl. G01L 5/00

(52) U.S. Cl. 73/760

(57) ABSTRACT

A tension measuring device for measuring the tension in new pipes when they are being pulled through old pipes or through the ground or other surrounding material in the process of replacing old pipes or installing pipes with the no-dig technology. The no-dig technology is performed with only a very limited digging.

The invention relates to a tension measuring device for measuring the tension in pipes when they are being pulled through old pipes or through the ground or other surrounding material.

When buried pipes have to be replaced or when new pipes have to be installed, the no-dig technology, which replaces the digging of a ditch, is a well known and widely used process.

By the no-dig technology a number of pits are dug at appreciable distances along the old pipe and the old pipe is removed in the pits to create access to the ends.

A number of rods are successively introduced through one open end of the old pipe and are successively joined by suitable means, whereby both ends of the old pipe are connected by a solid rod.

A variation of the no dig process is used when no pipe has been installed previously.

Here rods are successively pushed through the ground or other solid material and are successively joined by suitable means to create a solid rod which is steered through the ground or other material to appear at a predetermined opening, by suitable machinery.

At one end of the solid rod, installed by one the abovementioned methods, a pulling machine is erected and at the other end of the solid rod, a clamping device for clamping the new pipe is installed.

If the diameter of the new pipe is smaller than the original pipe, the clamping device just pulls the new pipe through the opening of the old pipe.

Often a larger diameter of the new pipe is demanded and a reamer or pipe cracking device has to be installed between the solid rod and the clamping device in order to provide an opening for the new pipe by expanding or cracking the old pipe or expanding the surrounding material.

A very important parameter of the no-dig process is to keep a record of the tension in the new pipe when it is being pulled through the old pipe or through the surrounding material.

A too high tension may destroy or shorten the operating life of the new pipe and therefore contractors today have to supply a record of the tension in the newly installed pipe through the complete pulling process.

For measuring the pulling force it is well known to equip the pulling machine with a force measuring device, but a serious limitation of this method lies in the fact that the often very high forces, necessary to expand or crack the old pipe, or the appreciable friction from pulling the solid rod through the old pipe or the surrounding material, will mask the actual tension in the new pipe and give high measuring errors.

It is also well known to introduce a recording device between the cracking device and the clamping device, which is inspected after the pulling process for documenting the maximum tension.

A limitation of this recording device is the lack of information during the pulling process.

It is the object of the invention to provide an improved measurement, during the pulling process, by installing a force measuring device which can accurately and reliably transmit the actual tension in the new pipe by suitable transmitting means to a receiving device mounted at a suitable place where the pulling process can be monitored and documented during the whole pulling process.

According to the invention this object is achieved by installing a force measuring device directly in connection with or integrated into the clamping device.

Hereby the actual tension in the new pipe can be measured and transmitted by a measuring device and transmitting device, mounted in the rather protected environment in the clamping device, as opposed to the very tough environments in the cracking device itself and between the cracking device and the clamping device.

In a first preferred embodiment of the invention the force measuring device and the transmitting device are mounted in the clamping device in direct connection with the opening of the new pipe.

In a further preferred embodiment of the invention the new pipe surrounds the force measuring device and the transmitting device.

In these embodiments both the force measuring device and the transmitting device are protected well against water and mud and secondly the new pipe provides convenient means for transmitting the signal, carrying the information on the actual tension in the new pipe, to a receiving device which may conveniently be placed at the other end of the new pipe.

The transmitting device may be a cable connected between the force measuring device and the receiving device with the cable preferably running inside the new pipe.

The transmitting and receiving devices may, according to the invention, instead of a cable connection, use electromagnetic or acoustic waves as media for transmitting the tension signal and the transmission may preferably, but not necessarily, take place through the opening of the new pipe.

The invention will now be described in further detail where,

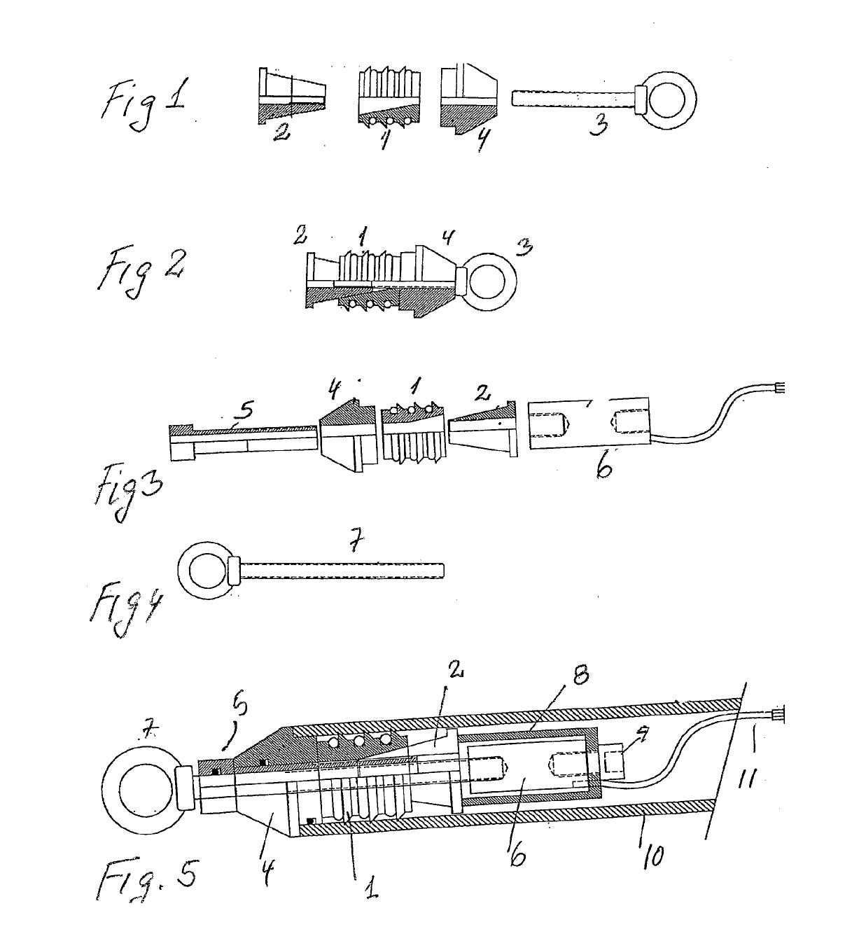

FIG. 1 shows the parts of a dismounted standard clamping device.

FIG. 2 shows the assembled standard clamping device of FIG. 1.

FIG. 3 shows parts of a dismounted preferred embodiment of a clamping device according to the invention.

FIG. 4 shows the pulling bolt for transmitting the tension in the new pipe to the force measuring device.

FIG. 5 shows the preferred embodiment of FIG. 3, assembled.

The clamping piece 1, in FIG. 1, which is split into three or more parts, is kept together by O-rings.

When a new pipe is pushed over the clamping device, protrusions on the clamping piece 1 cuts into the material of the inside of the new pipe as it is expanded by the conical part 2, when the bolt 3 is tightened against the cylindrical part 4.

The eye of the bolt 3 is connected to the solid rod or to the cracking device when the pulling process has to be started.

In FIG. 2, the clamping device of FIG. 1, is shown assembled.

In FIG. 3, a preferred embodiment of the invention is shown with the bored through bolt 5, provided for expanding the clamping piece 1 by the conical part 2, when tightened against the cylindrical part 4.

The force measuring device 6, is connected to the clamping device by the bolt 7, shown in FIG. 4.

FIG. 5 shows the above mentioned, preferred embodiment of the invention assembled with the force transmitting cylinder 8, which contains the force measuring device 6, fastened by the bolt 9.

The new pipe, 10 is seen mounted on the clamping device and protecting the force measuring device.

When a pulling force is applied to the bolt 7, which can move freely inside the hole in the bolt 5, the force is transmitted to the end of the force measuring device 6 which has a clearance to the end of the conical part 2.

A cable 11 is shown for transmitting the measuring signal to the receiver or to a transmitting device, which can be mounted inside the new pipe.

Due to the fact that a preferred embodiment of the invention has been illustrated and described herein, it will be apparent to those skilled in the art that modifications and improvements may be made to forms herein specifically disclosed.

Accordingly, the present invention is not to be limited to the forms which are specifically disclosed, the force measuring device may for example be a part of or mounted in the bolt 7.

1. Pipe tension measuring device for measuring the tension in pipes when they are being pulled through old pipes, through the ground or other surrounding materials by means of pipe pulling equipment, and comprising a pipe clamping device adapted to be inserted into an end of the pipe (10) and fastened thereto, a force measuring device (6) for measuring the pull in the pipe (10) and a transmitting device for transmitting information about the measured force to a receiving device, characterized in that the force measuring device (6) is integrated in the pipe clamping device so that in use when the pipe clamping device is fastened to the pipe end, the pipe surrounds to force measuring device (6) and the transmitting device.

2. Pipe tension measuring device according to claim 1, characterized in that the force measuring device constitutes a part of the clamping device.

3. Pipe tension measuring device according to claim 1, characterized in that the force measuring device is provided with a transmission device.

4. Pipe tension measuring device according to claim 1 characterized in that the transmission device utilizes the pipe for transmitting the signal.

5. Pipe tension measuring device according to claim 1, characterized in that the transmission device utilizes the surrounding material for transmitting the signal.

6. Pipe tension measuring device according to claim 1, characterized in that the transmission device utilizes acoustic waves.

7. Pipe tension measuring device according to claim 1, characterized in that the transmission device utilizes electromagnetic waves

8. Pipe tension measuring device according to claim 1, characterized in that the transmission device utilizes a cable connection.
